(19) United States
(12) Patent Application Publication
(10) Pub. No.: US 2026/0258704 A1
(43) Pub. Date: Sep. 3, 2026

(54) MULTI-MATERIAL BIT BLANK AND RELATED METHODS

(71) Applicant: Baker Hughes Oilfield Operations LLC, Houston, TX (US)

(72) Inventors: Rebecca Dar, Magnolia, TX (US); Stephen Manson Slavens, Houston, TX (US); John Abhishek Raj Bomidi, Peral River, NY (US)

(21) Appl. No.: 19/068,480

(22) Filed: Mar. 3, 2025

(51) Int. Cl. E21B 10/573; B22F 10/28; B33Y 10/00; B33Y 70/00; B33Y 80/00

(52) U.S. Cl. CPC E21B 10/573; B22F 10/28; B33Y 10/00; B33Y 80/00; B33Y 70/00

(57) ABSTRACT

An earth-boring rotary drill bit is disclosed. The earth-boring rotary drill bit includes a bit blank, a crown, and cutting elements. The bit blank includes a shank portion and a bonding portion. The shank portion includes one or more connection features. The shank portion includes a first material. The first material includes a metal or metal alloy. The bonding portion is unitarily formed as a single piece with the shank portion. The bonding portion includes a second material different than the first material. The second material includes a metal or metal alloy. The crown includes a particle-matrix composite material joined directly to the bonding portion. The crown surrounds the bonding portion. The cutting elements are joined to an exterior of the crown.

### FIELD

The present disclosure relates generally to earth-boring rotary drill bits, and more specifically to a bit blank formed of multiple materials that are unitarily formed as a single piece for earth-boring rotary drill bits and methods for forming the bit blank and the earth-boring rotary drill bits.

### BACKGROUND

Rotary drill bits are commonly used for drilling well bores in earth formations. One type of rotary drill bit is the fixed-cutter bit (often referred to as a “drag” bit), which typically includes a plurality of cutting elements secured to a face region of a bit body. The bit body frequently includes a steel blank embedded in a crown formed of a particle-matrix composite material that is more wear resistant than the steel. The steel blank is typically secured to a steel shank via a weld (and other features, such as a threaded connection). The shank is then used to secure the drill bit to the drill string.

Steel typically used for the steel blank may undergo a phase transformation from austenite to martensite as the steel blank cools with the crown after the crown has been cast around the steel blank within the mold. Stresses produced during this phase transformation may result in defects in the steel blank (e.g., cracking and distortion along the bond line) and deviations in bit body geometry relative to a designed geometry. Such defects can be detrimental to the efficiency and longevity of the resulting rotary drill bit.

### BRIEF SUMMARY

In various embodiments, the present disclosure provides an earth-boring rotary drill bit. The earth-boring rotary drill bit includes a bit blank, a crown, and cutting elements. The bit blank includes a shank portion and a bonding portion. The shank portion includes one or more connection features. The shank portion includes a first material. The first material includes a metal or metal alloy. The bonding portion is unitarily formed as a single piece with the shank portion. The bonding portion includes a second material different than the first material. The second material includes a metal or metal alloy. The crown includes a particle-matrix composite material joined directly to the bonding portion. The crown surrounds the bonding portion. The cutting elements are joined to an exterior of the crown.

In various embodiments, the present disclosure provides an earth-boring rotary drill bit. The earth-boring rotary drill bit includes a crown, cutting elements, and a bit blank. The crown includes a particle-matrix composite. The cutting elements are joined to an exterior of the crown. The bit blank includes a shank portion and a bonding portion. The shank portion includes a first material. The first material includes a metal or metal alloy. The shank portion includes one or more connection features. The bonding portion is at least partially embedded in the crown and joined to the crown. The bonding portion is unitarily formed as a single piece with the shank portion. The bonding portion includes a second material different than the first material. The second material includes a metal or metal alloy.

In various embodiments, the present disclosure provides a method for forming an earth-boring rotary drill bit. The method includes generating a shank portion of a bit blank with a first material. The first material includes a metal or a metal alloy. The method also includes generating a bonding portion of the bit blank with a second material. The second material includes a metal or a metal alloy that is different than the first material. The method also includes forming the shank portion and the bonding portion as a single unitary structure. The method further includes forming the shank portion and the bonding portion as a single unitary structure. The method even further includes forming a crown comprising a particle-matrix composite and bonding the crown directly to the bonding portion of the bit blank with the bonding portion at least partially embedded in the crown. The method also includes affixing cutting elements to the crown. The particle-matrix composite includes a matrix.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a partial cross-sectional side view of an earth-boring rotary drill bit having a bit blank formed of multiple materials;

FIG. 2 is a side view of the bit blank of FIG. 1 prior to formation of the earth-boring rotary drill bit;

FIG. 3 is a block diagram of an additive manufacturing machine for forming a bit blank, in accordance with embodiments of the present disclosure;

FIG. 4 is a flowchart of a method for generating a bit blank; and

FIG. 5 is a flowchart of a method for generating earth-boring rotary drill bit including the bit blank.

### DETAILED DESCRIPTION

In various embodiments, the present disclosure relates to a bit blank, formed of multiple materials, for earth-boring rotary drill bits and methods for forming the bit blank and the earth-boring rotary drill bits. The bit blank includes a shank portion and a bonding portion that are unitarily formed as a single piece, while being formed with different metal materials (e.g., metals or metal alloys, without limitation). Forming the portions of bit blank from different materials and as a single unitarily formed piece may simplify the manufacturing process of earth-boring rotary drill bits while also structurally improving the earth-boring rotary drill bits.

The shank portion may include a first material (e.g., a metal or metal alloy, without limitation) with a yield strength greater than 100 kilo pounds per square inch (ksi). The shank portion is configured for connecting the earth-boring rotary drill bit to a drill string. The bonding portion may include the second material that is weldable with a matrix of a particle-matrix composite material used for forming a crown of the earth-boring rotary drill bit. The metal of the bonding portion may remain in a same crystalline structure (e.g., a face-centered cubic structure, a body-centered cubic structure, or a hexagonal close-packed structure, without limitation) over a temperature range (e.g., between 20 degrees C. (about 70 degrees F.) and 1200 degrees C. (about 2200 degrees F.), without limitation) of a binder infiltration process used to form the crown and bond the crown to the bonding portion. By not changing phases during the binder infiltration process, stresses within the metal of the bonding portion may be reduced (as stresses associated with the phase transformation are not present). Reduced stresses in the bonding portion during the cooling process may prevent defects, such as liquid metal embrittlement from forming at a bonding interface between the shank portion and the crown. Further, by not changing phases during the cooling process, a volume of the bonding portion may remain constant during the cooling process, which may prevent defects, such as cracking, from occurring at the bonding interface.

The illustrations presented herein are not actual views of any system, device, or structure, or any component thereof, but are merely idealized representations, which are employed to illustrate and describe various embodiments.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any system, device, or structure, when utilized in a conventional manner. Furthermore, these terms may refer to an orientation of elements of any system, device, or structure, as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

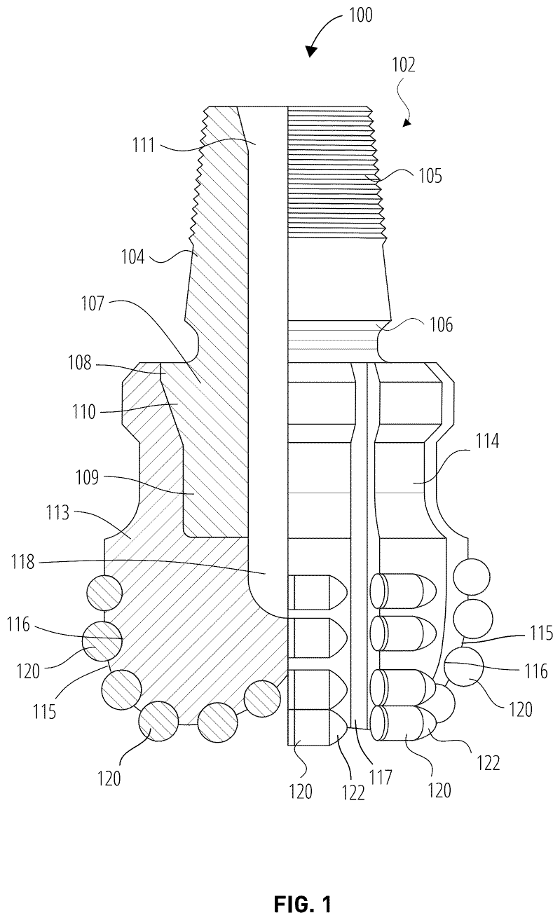

FIG. 1 is a partial cross-sectional side view of an earth-boring rotary drill bit 100 (hereinafter referred to as drill bit 100) having a bit blank 102 formed of multiple materials. Referring to FIG. 1, in various embodiments, the drill bit 100 includes a crown 113, cutting elements 120, and a bit blank 102.

The crown 113 may include a particle-matrix composite material such as, for example, particles of a hard, dense, corrosion-resistant material (e.g., tungsten carbide, without limitation) embedded in a matrix (e.g., a metal matrix, such as a copper alloy, without limitation). The crown 113 may include wings or blades 114 (hereinafter referred to as blades 114), junk slots 117, and crown fluid passages 118. The blades 114 may protrude radially outward and wrap around an end of the drill bit 100. Each of the blades 114 include multiple pockets 116 formed in a face 115 thereof. Each of the pockets 116 includes a recess formed in the respective blade 114 that is configured to receive one of the cutting elements 120.

Each of the junk slots 117 may be formed and extend between adjacent blades 114. The junk slots 117 may define a passageway for material removal. The crown fluid passages 118 may be formed in an interior of the crown 113 (e.g., within the particle-matrix composite material, without limitation) and include one or more axial passages (e.g., an axially extending counterbore, without limitation) and one or more nozzles extending from the one or more axial passages to an exterior surface of the crown 113 (e.g., to a face 115 of a blade 114 or to a junk slot 117, without limitation). The one or more nozzles may be configured to receive nozzle inserts at or adjacent to the exterior surface of the crown 113.

The cutting elements 120 may be fabricated separately from the crown 113 and attached, directly or indirectly to the crown 113. The cutting elements 120 may be joined to the crown 113 along the faces 115 of the blades 114 with each of the blades 114 being received in a respective pocket 116 formed in the blades 114. A second material (e.g., an adhesive or a braze alloy, without limitation) may be used to secure the cutting elements 120 to the crown 113. In various embodiments, the cutting elements 120 include either a disk shape or a substantially cylindrical shape. Each of the cutting elements 120 includes a cutting surface comprising a hard, super-abrasive material, such as mutually bound particles of polycrystalline diamond (e.g., on a substantially circular end surface of the cutting element 120, without limitation). The cutting elements 120 may be “polycrystalline diamond compact” (PDC) cutting elements.

The crown 113 may include buttresses 122 protruding from each of the blades 114. Each of the buttresses 122 may be positioned adjacent to a respective pocket 116 and may be configured to support the cutting element 120 received in the respective pocket 116 at a position opposite the cutting surface of the cutting element 120 (e.g., in a circumferential direction opposite a direction of rotation of the drill bit 100, without limitation). The buttresses 122 may be formed as a unitary structure with the blades 114 and other portions of the crown 113.

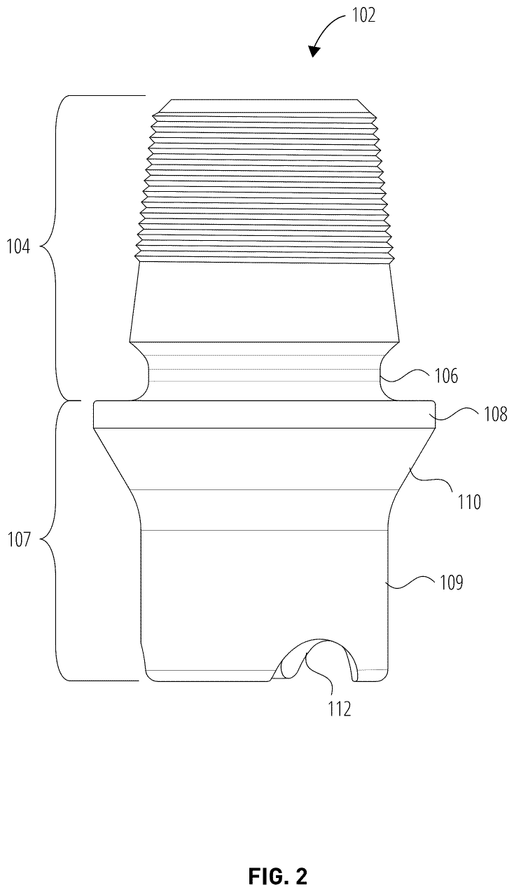

FIG. 2 is a side view of the bit blank 102 of FIG. 1 prior to formation of the earth-boring rotary drill bit 100. Referring to FIGS. 1 and 2, the bit blank 102 includes a shank portion 104 including a first material and a bonding portion 107 including a second material that is different than the first material. The first material and the second material are unitarily formed as a single piece (i.e., an undivided singular component/structure rather than two separately formed components later combined by a metal joining process, such as welding, brazing, soldering, fastening via a threaded connection, fastening via fasteners, or combinations thereof). In various embodiments, the shank portion 104 and the bonding portion 107 are unitarily formed as a single piece, the shank portion 104 including different material properties than the bonding portion 107. The bit blank 102 may be singularly formed in an additive manufacturing process, discussed in further detail below. The first material and the second material are bondable materials chosen from at least one of weldable materials (e.g., materials that are joinable via a metal fusion process, without limitation) that have high mutual solubility. Selecting metals that minimize differences in melting temperatures and coefficients of thermal expansion will typically result in stronger welds. Metal combinations that do not form brittle intermetallic compounds at elevated temperatures are desirable for joining in a metal fusion process.

The shank portion 104 includes one or more connection features 105 (e.g., external threads and/or internal threads, without limitation) configured for attaching the drill bit 100 to a drill string. The one or more connection features 105 may be formed during a primary manufacturing process of the bit blank 102 (e.g., a manufacturing process for forming the unitarily formed single piece, without limitation) or may be formed in a secondary manufacturing process (e.g., machining, without limitation). The one or more connection features 105 may be formed at or adjacent to an end of the shank portion 104 distal to the bonding portion 107.

The shank portion 104 may also include a body with an annular shape and an annular recess 106 formed in the body. The annular shape may be a cylindrical shape or a frustoconical shape. The annular recess 106 is a recess extending into the body around a circumference of the body of shank portion 104. The annular recess 106 may be positioned adjacent to the bonding portion 107 and may be configured to relieve stresses within the bit blank 102 during operation of the drill string. In various embodiments, the one or more connection features 105 are formed in the annular shape.

In various embodiments, the first material of the shank portion 104 includes a metal (e.g., a metal or metal alloy, without limitation) with a yield strength greater 100 ksi. The first material may include a low alloy steel, a stainless steel (e.g., 4130M7 or 17-4PH Stainless steel, without limitation), a precipitation hardening steel, or a maraging steel. Compositions typically will be iron (Fe)-base alloys with additions of chromium (Cr), manganese (Mn), nickel (Ni), molybdenum (Mo), or cobalt (Co), without limitation. These alloys can range from low alloy steels to stainless steels, such as precipitation hardening grades. Selection will be based on considerations such as mechanical properties, heat treatment requirements, coefficient of thermal expansion, melting temperature, galling or wear properties, machinability, and cost.

The bonding portion 107 is embedded in and bonded to the crown 113 via a bond formed between the second material of the bonding portion 107 and the matrix of the crown 113. The second material is weldable with the matrix (e.g., the second material and the matrix are materials that are joinable via a metal fusion process, without limitation) and has acceptable weldability with the shank portion 104. In various embodiments, the second material of the bonding portion 107 includes a metal (e.g., a metal or metal alloy, without limitation) with a melting point above a maximum temperature (e.g., within the range of 1090-1200 degrees C. (about 2000-2200 degrees F.), without limitation) reached during a binder infiltration process (e.g., a melting point above 1090 degrees C. (about 2000 degrees F.), above 1150 degrees C. (about 2100 degrees F.), above 1200 degrees C. (about 2200 degrees F.), or above 1260 degrees C. (about 2300 degrees F.), without limitation) used for forming the crown 113 and bonding the crown 113 to the bonding portion 107. Compositions typically will be rich in copper (Cu), nickel (Ni), zinc (Zn), silver (Ag), manganese (Mn), tin (Sn), and other elements that exhibit high solubility in the liquid and solid state with binder alloys, without limitation.

In various embodiments, the second material of the bonding portion 107 includes a primarily single crystalline structure (e.g., a face-centered cubic structure, a body-centered cubic structure, or a hexagonal close-packed structure, without limitation) over a temperature range of the binder infiltration process from a highest temperature of the matrix (e.g., a matrix material such as a copper alloy, without limitation) as the matrix is added to the hard, dense, corrosion-resistant material (e.g., tungsten carbide, without limitation) of the crown 113 to a lowest temperature of the matrix/crown 113 after completely cooling and bonding to the bonding portion 107 (i.e., the second material is non-phase transforming over the temperature range of the binder infiltration process and the crystalline structure thereof does not change over the temperature range, e.g., from a temperature of the matrix after cooling/room temperature, such as between 20 degrees C. and 1200 degrees C. (about 70 degrees F. and 2200 degrees F.), to a temperature of the matrix of the particle-matrix composite material after melting/a melting point of the matrix, such as within the range of 1090-1200 degrees C. (about 2000-2200 degrees F.), without limitation. The second material may include a nickel-based alloy (e.g., wrought alloys EN617, 625, 718, Cupronickel (CuNi) alloys, Monel Alloy 400, Nickel 200, without limitation) or custom alloys having compositions high in elements (e.g., nickel (Ni) and copper (Cu), without limitation) that have high solubility with the binder alloy. Nickel 200, for example, is 99% nickel with a melting temperature of 1435-1446 degrees C. (about 2615-2635 degrees F.). Monel Alloy 400 (composed of approximately 63% Ni and 28-34% Cu) has a melting point of 1300-1350 degrees C. (about 2370-2460 degrees F.).

In various embodiments, the bonding portion 107 includes a first region 108, a second region 109, and a transition region 110 that transitions between a shape of the first region 108 and a shape of the second region 109. The first region 108 may include a cylindrical shape (e.g., a right circular cylinder or hollow right circular cylinder, without limitation) with a first diameter, and the second region 109 may include a cylindrical shape (e.g., a right circular cylinder or hollow right circular cylinder, without limitation) with a second diameter, smaller than the first diameter. The transition region 110 may taper from the first region 108 to the second region 109 (e.g., a frustoconical shape transitioning from the first diameter to the second diameter, without limitation).

In various embodiments, the bit blank 102 includes one or more blank fluid passages 111. The one or more blank fluid passages 111 may include one or more passages extending axially through the shank portion 104 and the bonding portion 107 (e.g., a through bore formed in and extending through both the shank portion 104 and the bonding portion 107, without limitation) and one or more nozzle recesses 112 extending from the one or more passages to an exterior of the bonding portion 107. The one or more passages of the bit blank 102 may align with the one or more axial passages of the crown. Each of the one or more nozzle recesses 112 may be in fluid communication with at least a portion of one of the one or more nozzles of the crown 113.

In operation, the drill bit 100 is secured to the end of a drill string, which includes tubular pipe and equipment segments coupled end to end between the drill bit 100 and other drilling equipment at a surface of an earth formation above the well bore. The drill bit 100 is positioned at the bottom of a well bore such that the cutting elements 120 are adjacent the earth formation to be drilled. Equipment such as a rotary table or top drive may be used for rotating the drill string and the drill bit 100 within the well bore. Alternatively, the bit blank 102 of the drill bit 100 may be coupled directly to the drive shaft of a down-hole motor or steering unit, which then may be used to rotate the drill bit 100. As the drill bit 100 is rotated, drilling fluid is pumped to the faces 115 and/or the junk slots 117 of the crown 113 through the one or more blank fluid passages 111 and the crown fluid passages 118. Rotation of the drill bit 100 causes the cutting elements 120 to scrape across and shear away the surface of the underlying formation. The formation cuttings mix with and are suspended within the drilling fluid and pass through the junk slots 117 and an annular space between the well bore and the drill string to the surface of the earth formation.

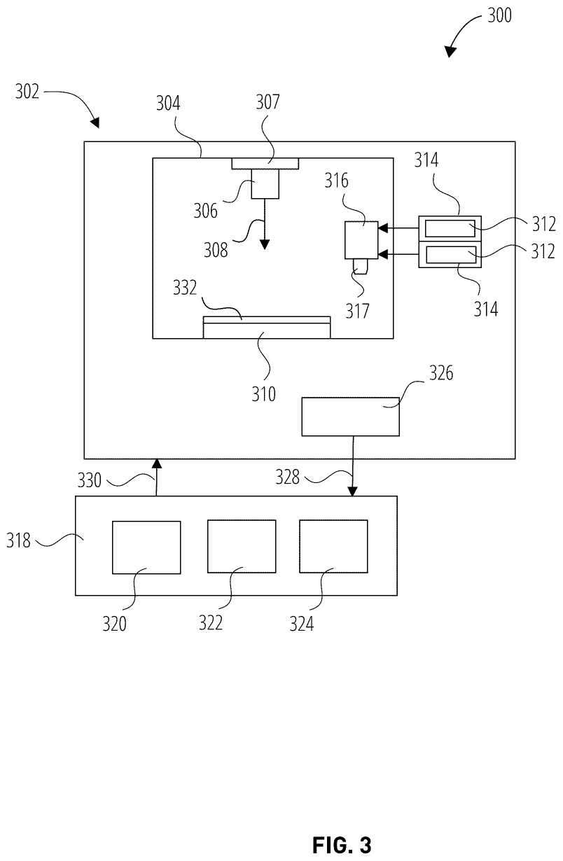

FIG. 3 is a block diagram of an additive manufacturing machine 300 for forming a bit blank, in accordance with embodiments of the present disclosure. The additive manufacturing machine 300 includes an additive manufacturing apparatus 302 and controller 318 operably coupled to the additive manufacturing apparatus 302. In embodiments, the additive manufacturing apparatus 302 is a direct energy powder and/or wire feedstock additive manufacturing machine (e.g., such as electric arc directed energy deposition, plasma directed energy deposition, laser directed energy deposition, or electron beam directed energy deposition additive manufacturing machines, without limitation). The additive manufacturing apparatus 302 may be another type of additive manufacturing machine (e.g., a binder based additive manufacturing machine, such as a binder jetting additive manufacturing machine, or other powder and/or wire feedstock additive manufacturing machines, such as selective laser sintering, a laser powder bed fusion additive manufacturing machine, or direct metal laser sintering additive manufacturing machines, without limitation).

The additive manufacturing apparatus 302 is adapted to receive a feedstock material 312 and manufacture an object 332 using the feedstock material 312. The object 332 may be a bit blank (e.g., the bit blank 102) or a green body that is sintered to form a bit blank.

In embodiments, the additive manufacturing apparatus 302 includes a build chamber 304, a build plate 310, a material feed 314, a material delivery system 316, and a focused energy source 306. The additive manufacturing apparatus 302 may also include a movement system 307 configured to move the focused energy source 306 within the build chamber 304. The movement system 307 may be a gantry system or a robotic arm, without limitation. The build plate 310 is positioned within the build chamber 304 and may be configured to be raised and lowered based on commands received by the additive manufacturing apparatus 302 from the controller 318. The build plate 310 is configured to support the object 332 being manufactured by the additive manufacturing apparatus 302.

The material feed 314 is configured to receive the feedstock material 312 to be used in the additive manufacturing of the object 332. In some embodiments, the material feed 314 is configured to provide the feedstock material 312 to the material delivery system 316, which in turn is configured to deliver the feedstock material 312 to the build plate 310 in the build chamber 304. In embodiments, the material delivery system 316 is configured to provide a feedstock material 312 that includes a powder (e.g., a metallic powder or a metal matrix composite powder or a wire, such as a metallic wire or metal matrix composite wire, without limitation). The material delivery system 316 may include a nozzle 317 configured to deposit the feedstock material 312 obtained from the material feed 314 to the build plate 310. The nozzle 317 may be moved separately from the focused energy source 306 or may be mounted on the movement system 307 and moved with the focused energy source 306. The material system 316 may include other components, such as rollers, without limitation, configured to move the feedstock material 312 from the material feed 314. In various embodiments, the additive manufacturing apparatus 302 includes at least two material feeds 314, each material feed 314 including a different material (e.g., the shank material and the bonding material discussed above, without limitation). The additive manufacturing apparatus 302 may include a single material delivery system 316 configured to selectively deliver the material from one of the at least two material feeds 314 at a time or a separate material feed 314 for each of the at least two material feeds 314 or may include multiple material delivery systems 316, one for each material feed 314, with a separate nozzle 314 for each material delivery system 316.

The focused energy source 306 is configured to direct focused energy 308 onto the feedstock material 312 to bond the feedstock material 312 together to form the object 332. The focused energy source 306 may be a laser source, an electron beam source, a plasma source, or an electric arc directed energy source, without limitation. The focused energy 308 may be a high-power laser, an electron beam, a plasma arc, or an electric arc, without limitation. The additive manufacturing apparatus 302 is configured to manufacture the object 332 on the build plate 310, layer by layer, as the feedstock material 312 is fed to the material feed 314, delivered to the build plate 310 by the material delivery system 316.

The controller 318 is configured to control at least a portion of operation of the additive manufacturing apparatus 302. The controller 318 is configured to control the additive manufacturing apparatus 302 using control signals 330 including commands configured to indicate to the additive manufacturing apparatus 302 specifics of operation. By way of non-limiting examples, the controller 318 is configured to control operation of the material delivery system 316, operation of the focused energy source 306, the movement system 307, other operations, or combinations thereof.

In various embodiments, the controller 318 includes a processor 320, memory 322, and one or more storage device 324. The memory 322 stores computer-executable instructions that, when executed, cause the processor 320 to control the additive manufacturing apparatus 302 in any manner disclosed herein, to perform any relevant method as disclosed herein, or to produce the object 332. The storage device 324 is configured to store manufacturing instructions, input factors for the manufacturing process, and the like.

In various embodiments, the additive manufacturing machine 300 includes one or more monitoring devices 326 configured to obtain data related to at least one of the additive manufacturing apparatus 302 and the additive manufacturing process. The one or more monitoring devices 326 may be integrated into the additive manufacturing apparatus 302, separate from the additive manufacturing apparatus 302, or a combination thereof. The one or more monitoring devices 326 may be configured to send data to the controller 318 via monitoring signals 328.

In various embodiments, the additive manufacturing machine 300 is a hybrid machine and includes an integrated automated machining tool (e.g., a multi-axis Computer Numerical Control (CNC) machine, without limitation) configured for material removal. This allows both the additive and material removal process to be integrated within a singular system and process.

In various embodiments, the additive manufacturing machine 300 is configured to generate a bit blank as a unitarily formed single piece or is configured to generate a green body that is sintered to generate a bit blank as a unitarily formed single piece

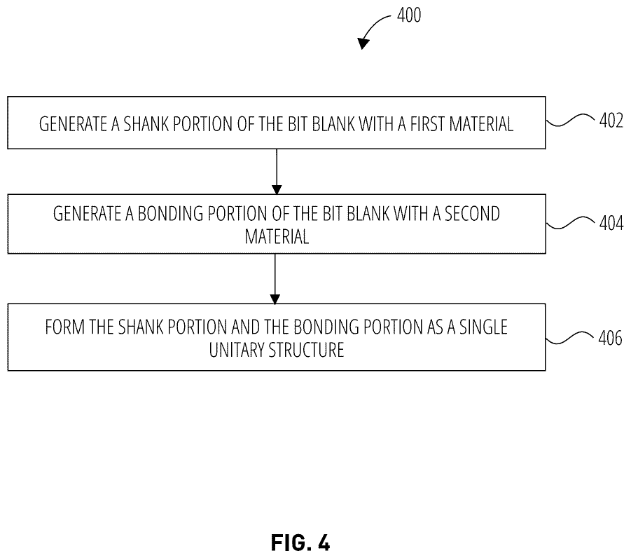

FIG. 4 a flowchart of a method 400 for generating a bit blank. The method includes generating a shank portion of the bit blank with a first material at act 402. The shank portion may be the shank portion 104 of the bit blank 102. The first material includes a metal or a metal alloy and may be any embodiment of the first material disclosed herein. The method also includes generating a bonding portion of the bit blank with a second material at act 404. The bonding portion may be the bonding portion 107 of the bit blank 102. The second material includes a metal or a metal alloy and may be any embodiment of the second material disclosed herein.

The method also includes forming the shank portion and the bonding portion as a single unitary structure at act 406. In various embodiments, acts 402 and 404 include additively manufacturing the shank portion and the bonding portion and act 406 includes transitioning from generating layers of one of the shank portion and the bonding portion to generating layers of the other of the shank portion and the bonding portion, while maintaining a single unitary structure between the layers of the shank portion and the layers of the bonding portion. Acts 402, 404, and 406 are configured to unitarily form the bit blank as a single piece (i.e., an undivided singular component/structure rather than two separately formed components later combined by a metal joining process, such as welding, brazing, soldering, fastening via a threaded connection, fastening via fasteners, or combinations thereof).

In various embodiments, act 406 includes generating layers with a mixture of the first material and the second material between layers of the first material and layers of the second material. In other various embodiments, act 406 includes generating a layer of the second material directly on a layer of the first material or a layer of the first material directly on a layer of the second material. In various embodiments, act 406 includes depositing a buttering layer comprising a third material between the first material and the second material. The third material being a material that is soluble with the first material and the second material. The buttering layer may improve weldability of the two materials. For example, low alloy steel can be “buttered” with ERNi (nickel filler metal) prior to welding with a copper-base alloy as nickel base alloys can tolerate high amounts of iron dilution (alloying with iron).

The first material and the second material are bondable materials. The bondable materials may be chosen from among weldable materials (e.g., materials that are joinable via a metal fusion process, without limitation) and sinterable materials (e.g., materials that are formed as a green body and sintered to form a unitary single piece, without limitation). In various embodiments, acts 402, 404, and 406 are performed using the additive manufacturing machine 300 (e.g., a wire arc, plasma arc, electron beam, or laser direct energy deposition machine, without limitation) or a similar additive manufacturing machine (e.g., a laser powder bed fusion additive manufacturing machine, a selective laser sintering additive manufacturing machine, or a direct metal laser sintering additive manufacturing machine, without limitation). In various embodiments, acts 402 and 404 generate a green body, and act 406 includes sintering the green body to form the shank portion and the bonding portion as a single unitary structure.

The method 400 may include forming one or more fluid passages in at least one of the first portion and the second portion. The fluid passages may be formed in the at least one of the first portion and the second portion during the additive manufacturing process, with a machining process, or with a combination thereof. The machining process may be integrated into the additive manufacturing process utilizing a hybrid additive manufacturing machine that includes an integrated automated machining tool (e.g., a multi-axis Computer Numerical Control (CNC) machine, without limitation). The method 400 may also include forming one or more connection features in the shank portion. The one or more connection features may be formed in the shank portion during the additive manufacturing process, with a machining process, or with a combination thereof (e.g., utilizing a hybrid additive manufacturing machine, without limitation). The method 400 may also include forming other features of the shank portion and the bonding portion (e.g., an annular recess in the shank portion, without limitation) during the additive manufacturing process, with a machining process, or with a combination thereof (e.g., utilizing a hybrid additive manufacturing machine, without limitation).

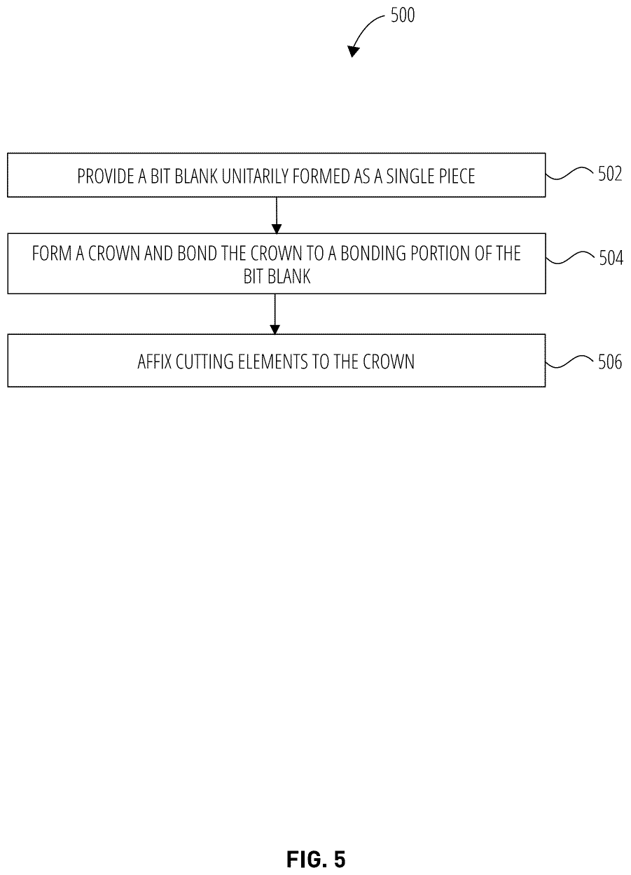

FIG. 5 is a flowchart of a method 500 for generating earth-boring rotary drill bit including the bit blank. The method 500 includes providing a bit blank unitarily formed as a single piece at act 502. The bit blank being a bit blank including a shank portion and a bonding portion that are unitarily formed as a single piece. The bit blank may be the bit blank formed by the method of FIG. 4 and may be the bit blank 102. The bit blank may include any of the features of the bit blank 102 disclosed herein.

The method also includes forming a crown and bonding the crown to a bonding portion of the bit blank at act 504. Act 504 may include an infiltration process to form the crown of a particle-matrix composite material within a mold and bond the crown directly to the bonding portion of the bit blank. The infiltration process may include positioning the bonding portion at least partially in the mold (all or a portion of the bonding portion may be inserted into the mold), inserting particles of a hard, dense, corrosion-resistant material (e.g., tungsten carbide, without limitation) into the mold around at least a portion of the bonding portion, melting a matrix (e.g., copper alloy matrix, without limitation), causing the matrix to infiltrate the particles (e.g., pouring the melted matrix into the mold, without limitation), and cooling the matrix (e.g., allow the matrix to cool, without limitation), which forms the crown and bonds the bonding portion to the crown. During act 504, only the bonding portion is in contact with the particles and the melted matrix. As such, a bond between the bit blank (at the bonding portion) and the crown is formed without exposing the shank portion to the heat of the melted matrix during the infiltration process, which may prevent the shank portion from a phase transformation between crystalline structures (e.g., undergoing a phase transformation from austenite to martensite while cooling from the upper temperatures of the infiltration process, without limitation), which may prevent cracking or other defects from occurring caused by stresses associated with a volume change during phase transformations.

Act 504 may also include vibrating the mold or the particles to decrease the amount of space between adjacent particles and pack the particles. Act 504 may also include inserting displacements within the mold prior to positioning the particles therein. The displacements may facilitate formation of features, such as fluid passageways, junk slots, and cutting element pockets. Other processes for forming the cutting element pockets may also be used.

The method 500 further includes affixing cutting elements to the crown at act 506. The cutting elements may be affixed to the crown by brazing, mechanical affixation, or adhesive affixation, without limitation.

The various illustrative logical blocks, modules, and circuits described in connection with the embodiments of the additive manufacturing machine 300, and in particular, the controller 318, disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

While embodiments of the bit blank discussed herein are described in connection with an earth-boring rotary drill bit, the bit blank may also be utilized within other drill bits, earth-boring tools, or similar components and tools optionally with modifications that would be apparent to a person having ordinary skill in the art. The term “earth-boring tool” includes any type of bit or tool used for drilling during the formation or enlargement of a wellbore in a subterranean formation. For example, earth-boring tools include fixed-cutter bits, roller cone bits, percussion bits, core bits, eccentric bits, bicenter bits, reamers, mills, drag bits, hybrid bits (e.g., rolling components in combination with fixed cutting elements), and other drilling bits and tools known in the art.

Non-limiting example embodiments of the present disclosure may include:
Embodiment 1: An earth-boring rotary drill bit, comprising: a bit blank comprising: a shank portion including one or more connection features, the shank portion comprising a first material, the first material comprising a metal or metal alloy; and a bonding portion unitarily formed as a single piece with the shank portion, the bonding portion comprising a second material different than the first material, the second material comprising a metal or metal alloy; a crown comprising a particle-matrix composite material joined directly to the bonding portion, the crown surrounding the bonding portion; and cutting elements joined to an exterior of the crown.
Embodiment 2: The bit blank according to Embodiment 1, wherein the first material has a yield strength greater than 100 kilo pounds per square inch (ksi).
Embodiment 3: The bit blank according to any of Embodiments 1 and 2, wherein the second material has a single crystalline structure over a temperature range between 20 degrees C. and 1200 degrees C.
Embodiment 4: The bit blank according to any of Embodiments 1 through 3, wherein the second material is a metal with a melting point above 1200 degrees Celsius.
Embodiment 5: The bit blank according to any of Embodiments 1 through 4, wherein the first material is chosen from among a low alloy steel, stainless steel, a precipitation hardening steel, and a maraging steel, and wherein the second material is chosen from among a nickel-based alloy, a copper-based alloy, and a combination thereof.
Embodiment 6: The bit blank according to any of Embodiments 1 through 5, wherein the one or more connection features include threads.
Embodiment 7: The bit blank according to any of Embodiments 1 through 6, wherein the shank portion includes an annular recess formed in a body of the shank portion, the annular recess extending around a circumference of the body adjacent to the bonding portion.
Embodiment 8: An earth-boring rotary drill bit, comprising: a crown comprising a particle-matrix composite material; cutting elements joined to an exterior of the crown; and a bit blank comprising: a shank portion comprising a first material, the first material comprising a metal or metal alloy, the shank portion including one or more connection features; and a bonding portion at least partially embedded in the crown and joined directly to the crown, the bonding portion unitarily formed as a single piece with the shank portion, the bonding portion comprising a second material different than the first material, the second material comprising a metal or metal alloy.
Embodiment 9: The earth-boring rotary drill bit according to Embodiment 8, wherein the first material has a yield strength greater than 100 kilo pounds per square inch (ksi).
Embodiment 10: The earth-boring rotary drill bit according to any of Embodiments 8 and 9, wherein the second material has a single crystalline structure between 20 degrees C. and a melting point of a matrix of the particle-matrix composite material.
Embodiment 11: The earth-boring rotary drill bit according to any of Embodiments 8 through 10, wherein the second material is a metal with a melting point above 1200 degrees C.
Embodiment 12: The earth-boring rotary drill bit according to any of Embodiments 8 through 11, wherein the one or more connection features include external threads.
Embodiment 13: The earth-boring rotary drill bit according to any of Embodiments 8 through 12, wherein the shank portion includes an annular recess formed in a body of the shank portion, the annular recess extending around a circumference of the body adjacent to the bonding portion.
Embodiment 14: A method for forming an earth-boring rotary drill bit, the method comprising: generating a shank portion of a bit blank with a first material, the first material comprising a metal or a metal alloy; generating a bonding portion of the bit blank with a second material, the second material comprising a metal or a metal alloy that is different than the first material; forming the shank portion and the bonding portion as a single unitary structure; forming a crown comprising a particle-matrix composite and bonding the crown directly to the bonding portion of the bit blank with the bonding portion at least partially embedded in the crown; and affixing cutting elements to the crown, wherein the particle-matrix composite comprises a matrix.
Embodiment 15: The method according to Embodiment 14, wherein forming the shank portion and the bonding portion as a single unitary structure includes transitioning from generating layers of one of the shank portion and the bonding portion to generating layers of the other of the shank portion and the bonding portion, while maintaining a single unitary structure between the layers of the shank portion and the layers of the bonding portion.
Embodiment 16: The method according to any of Embodiments 14 and 15, wherein the transitioning includes generating layers with a mixture of the first material and the second material between layers of the first material and layers of the second material.
Embodiment 17: The method according to any of Embodiments 14 through 16, wherein the transitioning includes generating a layer of the second material directly on a layer of the first material or a layer of the first material directly on a layer of the second material.
Embodiment 18: The method according to any of Embodiments 14 through 17, wherein the first material has a yield strength greater than 100 kilo pounds per square inch (ksi).
Embodiment 19: The method according to any of Embodiments 14 through 18, wherein the transitioning includes depositing a buttering layer comprising a third material between the first material and the second material, the third material being a material that is soluble with the first material and the second material.
Embodiment 20: The method according to any of Embodiments 14 through 19, wherein forming the crown includes an infiltration process that includes: positioning the bonding portion at least partially in a mold; inserting particles into the mold and around at least a portion of the bonding portion; melting the matrix; causing the matrix to infiltrate the particles; and cooling the matrix, and wherein the second material has a single crystalline structure over a temperature range of the infiltration process from a temperature of the matrix while melted to a temperature of the matrix after cooling thereof.
Embodiment 21: The method according to any of embodiments 14 through 20, wherein forming the shank portion and the bonding portion as a single unitary structure includes utilizing an additive manufacturing machine to generate the layers of the shank portion and the layers of the bonding portion and to transition therebetween to form the single unitary structure, wherein the additive manufacturing machine is chosen from among a direct energy powder additive manufacturing machine, a wire feedstock additive manufacturing machine, and a binder based additive manufacturing machine, and wherein the additive manufacturing machine is configured to generate the bit body with a unitary single structure or a green body that is sintered into the bit body with the unitary single structure.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. An earth-boring rotary drill bit, comprising:
a bit blank comprising:
a shank portion including one or more connection features, the shank portion comprising a first material, the first material comprising a metal or metal alloy; and
a bonding portion unitarily formed as a single piece with the shank portion, the bonding portion comprising a second material different than the first material, the second material comprising a metal or metal alloy;
a crown comprising a particle-matrix composite material joined directly to the bonding portion, the crown surrounding the bonding portion; and
cutting elements joined to an exterior of the crown.

2. The bit blank of claim 1, wherein the first material has a yield strength greater than 100 kilo pounds per square inch (ksi).

3. The bit blank of claim 1, wherein the second material has a single crystalline structure over a temperature range between 20 degrees C. and 1200 degrees C.

4. The bit blank of claim 1, wherein the second material is a metal with a melting point above 1200 degrees C.

5. The bit blank of claim 1, wherein the first material is chosen from among a low alloy steel and stainless steel, a precipitation hardening steel, and a maraging steel, and wherein the second material is chosen from among a nickel-based alloy, a copper-based alloy, and a combination thereof.

6. The bit blank of claim 1, wherein the one or more connection features include threads.

7. The bit blank of claim 1, wherein the shank portion includes an annular recess formed in a body of the shank portion, the annular recess extending around a circumference of the body adjacent to the bonding portion.

8. An earth-boring rotary drill bit, comprising:
a crown comprising a particle-matrix composite material;
cutting elements joined to an exterior of the crown; and
a bit blank comprising:
a shank portion comprising a first material, the first material comprising a metal or metal alloy, the shank portion including one or more connection features; and
a bonding portion at least partially embedded in the crown and joined directly to the crown, the bonding portion unitarily formed as a single piece with the shank portion, the bonding portion comprising a second material different than the first material, the second material comprising a metal or metal alloy.

9. The earth-boring rotary drill bit of claim 8, wherein the first material has a yield strength greater than 100 kilo pounds per square inch (ksi).

10. The earth-boring rotary drill bit of claim 9, wherein the second material has a single crystalline structure between 20 degrees C. and a melting point of a matrix of the particle-matrix composite material.

11. The earth-boring rotary drill bit of claim 9, wherein the second material is a metal with a melting point above 1200 degrees C.

12. The earth-boring rotary drill bit of claim 9, wherein the one or more connection features include threads.

13. A method for forming an earth-boring rotary drill bit, the method comprising:
generating a shank portion of a bit blank with a first material, the first material comprising a metal or a metal alloy;
generating a bonding portion of the bit blank with a second material, the second material comprising a metal or a metal alloy that is different than the first material;
forming the shank portion and the bonding portion as a single unitary structure;
forming a crown comprising a particle-matrix composite and bonding the crown directly to the bonding portion of the bit blank with the bonding portion at least partially embedded in the crown; and
affixing cutting elements to the crown,
wherein the particle-matrix composite comprises a matrix.

14. The method of claim 13, wherein forming the shank portion and the bonding portion as a single unitary structure includes transitioning from generating layers of one of the shank portion and the bonding portion to generating layers of the other of the shank portion and the bonding portion, while maintaining a single unitary structure between the layers of the shank portion and the layers of the bonding portion.

15. The method of claim 14, wherein the transitioning includes generating layers with a mixture of the first material and the second material between layers of the first material and layers of the second material.

16. The method of claim 14, wherein the transitioning includes generating a layer of the second material directly on a layer of the first material or a layer of the first material directly on a layer of the second material.

17. The method of claim 14, wherein forming the shank portion and the bonding portion as a single unitary structure includes utilizing an additive manufacturing machine to generate the layers of the shank portion and the layers of the bonding portion and to transition therebetween to form the single unitary structure, wherein the additive manufacturing machine is chosen from among a direct energy powder additive manufacturing machine, a wire feedstock additive manufacturing machine, and a binder based additive manufacturing machine, and wherein the additive manufacturing machine is configured to generate the bit body with a unitary single structure or a green body that is sintered into the bit body with the unitary single structure.

18. The method of claim 13, wherein the first material has a yield strength greater than 100 kilo pounds per square inch (ksi).

19. The method of claim 13, wherein the transitioning includes depositing a buttering layer comprising a third material between the first material and the second material, the third material being a material that is soluble with the first material and the second material.

20. The method of claim 13, wherein forming the crown includes an infiltration process that includes:
positioning the bonding portion at least partially in a mold;
inserting particles into the mold and around at least a portion of the bonding portion; melting the matrix; causing the matrix to infiltrate the particles; and
cooling the matrix, and
wherein the second material has a single crystalline structure over a temperature range of the infiltration process from a temperature of the matrix while melted to a temperature of the matrix after cooling thereof.
